(19) United States
(12) Patent Application Publication
(10) Pub. No.: US 2015/0234927 A1
(43) Pub. Date: Aug. 20, 2015

(54) APPLICATION SEARCH METHOD, APPARATUS, AND TERMINAL

(71) Applicant: Tencent Technology (Shenzhen) Company Limited, Shenzhen (CN)

(72) Inventors: Yuancheng CAO, Shenzhen (CN); Yue CAO, Shenzhen (CN); Huabin YIN, Shenzhen (CN); Hejun NING, Shenzhen (CN); Jiantao GONG, Shenzhen (CN)

(73) Assignee: TENCENT TECHNOLOGY (SHENZHEN) COMPANY LIMITED, Shenzhen (CN)

(21) Appl. No.: 14/704,249

(22) Filed: May 5, 2015

Related U.S. Application Data
(63) Continuation of application No. PCT/CN2013/084566, filed on Sep. 29, 2013.

(30) Foreign Application Priority Data
Nov. 6, 2012 (CN) 201210438307.0

(51) Int. Cl. G06F 17/30

(52) U.S. Cl. CPC G06F 17/30867; G06F 17/30598; G06F 17/30997

(57) ABSTRACT

Described are an application search method, apparatus, and terminal. In the method the terminal acquires a search word and converts the search word to a tag in a pre-constructed tag library, where the tag in the tag library corresponds to one category of applications. The terminal queries for applications corresponding to the tag and uses the applications as a search result corresponding to the search word. The apparatus may be implemented in the terminal and may include: an acquiring module, a conversion module, and a query module. In the present disclosure, a search word is converted to a tag in a pre-constructed tag library, and applications are searched for according to the tag.

### CROSS-REFERENCE RELATED APPLICATIONS

This application is continuation of International Application No. PCT/CN2013/084566, filed on Sep. 29, 2013, and entitled “APPLICATION SEARCH METHOD, APPARATUS, AND TERMINAL” 1, which claims priority to Chinese Patent Application No. 201210438307.0, entitled “APPLICATION SEARCH METHOD, APPARATUS, AND TERMINAL”, filed on Nov. 6, 2012 with the Chinese State Intellectual Property Office, both of which are incorporated by reference in their entireties.

### FIELD OF THE TECHNOLOGY

The present disclosure relates to the field of search technologies, and in particular, to an application search method, apparatus, and terminal.

### BACKGROUND OF THE DISCLOSURE

With the continuous development of computer technologies, various applications have been continuously developed, and accordingly, the types and functions of applications have increased. How to find applications that meet user demands from numerous types of applications becomes a key factor for improving user experience.

In a common scenario, when applications are searched for, first, a word library including various key words is constructed, and corresponding list content is assigned to each key word. If a search word requested by a user is fully consistent with a key word in the word library, applications corresponding to the list content corresponding to the key word are returned as a search result. For example, a key word is “antivirus”, and a list content assigned to the key word is “security category”; in this case, if a search word requested by a user is “antivirus”, applications under the list content “security category” are returned to the user after being sorted according to a certain rule.

In the common scenario, when applications are searched for, a corresponding search result can be returned only when a search word requested by a user is fully consistent with a key word in the word library, which indicates relatively high requirements on search, resulting in that the existing method for searching for applications has certain limitations and low flexibility.

### SUMMARY

In view of the above, embodiments of the present invention provide an application search method, apparatus, and terminal. The technical solutions are described as follows:

According to one aspect, an application search method is provided, including: acquiring a search word and converting the search word to a tag in a pre-constructed tag library, each tag in the tag library corresponding to one category of applications; and querying for applications corresponding to the tag obtained through conversion, and using the applications as a search result corresponding to the search word.

According to yet another aspect, a terminal is provided, including:

one or more processors; and a memory; the memory having one or more programs stored therein, the one or more programs being configured to be executed by the one or more processors, and the one or more programs including instructions used for executing the following operations: acquiring a search word and converting the search word to a tag in a pre-constructed tag library, each tag in the tag library corresponding to one category of applications; and querying for applications corresponding to the tag obtained through conversion, and using the applications as a search result corresponding to the search word.

A non-transitory computer readable storage medium having stored therein one or more instructions, which, when executed by a terminal, cause the terminal to: acquiring a search word and converting the search word to a tag in a pre-constructed tag library, each tag in the tag library corresponding to one category of applications; and querying for applications corresponding to the tag obtained through conversion, and using the applications as a search result corresponding to the search word.

In the embodiments, a search word is converted to a tag in a pre-constructed tag library, and applications are searched for according to the tag. Because the matching of search words and tags is relatively flexible, not only search limitations can be reduced, but also the flexibility of search can be improved.

### BRIEF DESCRIPTION OF THE DRAWINGS

To describe the technical solutions of the embodiments of the present invention more clearly, the accompanying drawings for illustrating the embodiments will be introduced briefly in the following. Apparently, the accompanying drawings in the following description show only some embodiments of the present invention, and a person of ordinary skill in the art may obtain other drawings based on these accompanying drawings without creative efforts.

FIG. 1 is a flowchart of an application search method according to an embodiment of the present invention;

FIG. 2 is a flowchart of an application search method according to an embodiment of the present invention;

FIG. 3 is a schematic structural diagram of a first application search apparatus according to an embodiment of the present invention;

FIG. 4 is a schematic structural diagram of a second application search apparatus according to an embodiment of the present invention;

FIG. 5 is a schematic structural diagram of a third application search apparatus according to an embodiment of the present invention;

FIG. 6 is a schematic structural diagram of a fourth application search apparatus according to an embodiment of the present invention; and

FIG. 7 is a schematic structural diagram of a terminal according to an embodiment of the present invention.

### DESCRIPTION OF EMBODIMENTS

To make the objectives, technical solutions, and advantages of the present disclosure clearer, the following further describes the embodiments of the present invention in detail with reference to the accompanying drawings.

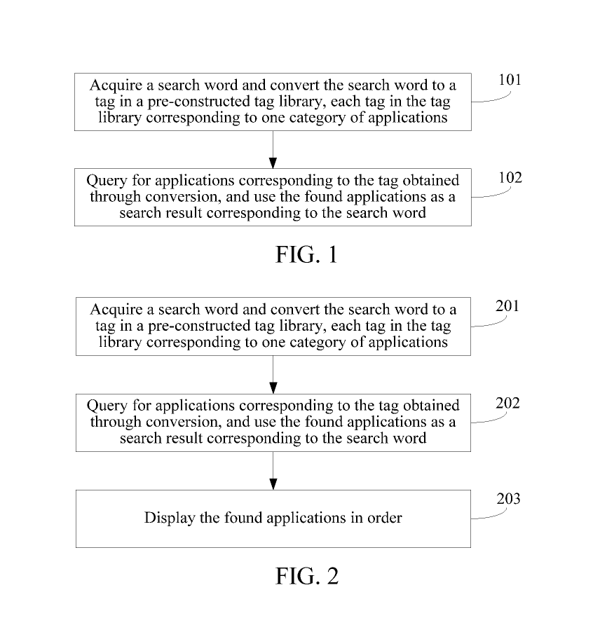

An embodiment of the present invention provides an application search method. In this method, a search word is converted to a tag, and applications are searched for according to the tag, so as to reduce search limitations, thereby improving the flexibility of search. Referring to FIG. 1, the process of the method provided in this embodiment is specifically as follows:

101: Acquire a search word and convert the search word to a tag in a pre-constructed tag library, each tag in the tag library corresponding to one category of applications.

Further, each tag in the tag library corresponds to one or more characteristic words; and

the converting the search word to a tag in a pre-constructed tag library includes but is not limited to:

calculating degrees of association between the search word and the characteristic words in the tag library, and determining a characteristic word matching the search word according to the calculated degrees of association; and

querying for a tag corresponding to the matching characteristic word, and using the found tag in the query results as the tag obtained by converting the search word.

Further, before the converting the search word to a tag in a pre-constructed tag library, the method further includes:

collecting search resources and extracting key words from the collected search resources;

determining tags according to the extracted key words, and determining a characteristic word corresponding to each tag; and

storing the determined tags and characteristic words into a corresponding database to obtain the tag library.

102: Query for applications corresponding to the tag obtained through conversion, and use the applications as a search result corresponding to the search word.

Further, before the querying for applications corresponding to the tag obtained through conversion, the method further includes:

collecting applications, and determining, according to text information of the collected applications, tags in the tag library that correspond to the applications.

Further, after the using the applications as a search result corresponding to the search word, the method further includes:

displaying the applications in order.

In the method provided in this embodiment, a search word is converted to a tag in a pre-constructed tag library, and applications are searched for according to the tag. Because the matching of search words and tags is relatively flexible, not only search limitations can be reduced, but also the flexibility of search can be improved.

To explain the application search method provided in the foregoing embodiment more clearly, the application search method is described in detail with reference to the content of the foregoing embodiment by using the following embodiment as an example. For details, refer to the following embodiment.

An embodiment of the present invention provides an application search method. With reference to the content of the foregoing embodiment, referring to FIG. 2, the process of the method provided in this embodiment is specifically as follows:

201: Acquire a search word and convert the search word to a tag in a pre-constructed tag library, each tag in the tag library corresponding to one category of applications.

As regards this step, this embodiment does not limit the manner of acquiring a search word. During specific implementation, an existing manner of acquiring a search word may be used, for example, a search word input interface may be first provided for a user by using a graphical user interface (GUI), and after the user inputs a search word by using the input interface, the search word that is input by the user is acquired and is used as the acquired search word.

In order to convert the search word to a corresponding tag, before the converting the search word to a tag in a pre-constructed tag library in this step, the method further includes a procedure of constructing a tag library. There are various manners of constructing a tag library. The manner used in this embodiment includes but is not limited to:

collecting search resources and extracting key words from the collected search resources;

determining tags according to the extracted key words, and determining a characteristic word corresponding to each tag; and

storing the determined tags and characteristic words into a corresponding database to obtain the tag library.

The search resources include, but are not limited to, search resources related to applications on various search websites, such as search content and search words of common applications, and may specifically be collected by accessing the search websites; and key words may be extracted from the collected search resources according to an existing manner of extracting key words. This embodiment does not limit the specific manner of collecting search resources, specific content of the search resources, the manner of extracting key words, and content of the extracted key words. As regards the extracted key words, because they can reflect certain characteristics of the applications, tags covering various characteristics of the applications are determined according to the extracted key words in this embodiment, for example, an “antivirus” tag can be determined according to key words such as killing Trojan horse and antivirus scanning, a “system optimization” tag can be determined according to key words such as junk cleaning, cache cleaning, and track cleaning, and so on. Certainly, in addition to the key words and tags determined in the foregoing examples, many other tags can be determined according to other key words. This embodiment does not limit the manner of determining a tag according to key words and the determined specific tag.

In addition, one or more tags may be determined according to one or more key words. After each tag is determined, all the key words for determining the tag may be used as characteristic words corresponding to the tag, or a preset number of key words may be selected from all the key words for determining the tag as characteristic words corresponding to the tag. No matter how characteristic words are determined, each tag in the tag library corresponds to one or more characteristic words. For example, tags include but are not limited to “antivirus”, “system optimization”, “anti-deduction”, and the like; characteristic words corresponding to the “antivirus” tag include but are not limited to “killing Trojan horse”, “Trojan horse scanning”, “system scanning”, and the like; characteristic words corresponding to the “system optimization” tag include but are not limited to “junk cleaning”, “cache cleaning”, “track cleaning”, and the like; characteristic words corresponding to the “anti-deduction” tag include but are not limited to “deduction scanning”, “anti-deduction”, and the like.

Further, on the basis of the correspondence between the tags and the characteristic words, an implementation manner of converting the search word to a tag in a pre-constructed tag library in this step includes but is not limited to:

calculating degrees of association between the search word and the characteristic words in the tag library, and determining a characteristic word matching the search word according to the calculated degrees of association; and

querying for a tag corresponding to the matching characteristic word, and using the found tag in the query results as the tag obtained by converting the search word.

In the existing technology, there are mature methods available for calculating the degree of association between two words; therefore the calculating degrees of association between the search word and the characteristic words in the tag library in this step can be implemented by using the existing technology, which is not specifically limited in this embodiment.

It should be noted that the process of constructing a tag library may be executed when the method provided in this embodiment is executed for the first time, that is, once the tag library is constructed, there is no need to construct a tag library for each application search process, but instead, the tag library that is already constructed can be used. In addition, with update of network words, the method provided in this embodiment also supports a procedure of updating the tag library after the tag library is constructed. The principle of the specific update process is the same as that of the manner of building a tag library, and details are not further described herein.

202: Query for applications corresponding to the tag obtained through conversion, and use the applications as a search result corresponding to the search word.

Specifically, because each tag corresponds to one category of applications, after the search word is converted to a tag in the pre-constructed tag library, it can be considered that the search word matches the one category of applications corresponding to the tag obtained through conversion, and therefore, after the applications corresponding to the tag obtained through conversion are queried for, the applications are used as a search result corresponding to the search word.

Further, as regards which category of applications that each tag specifically corresponds to, before the querying for applications corresponding to the tag obtained through conversion, the method provided in this embodiment further includes a procedure of determining a correspondence between applications and tags, which specifically includes but is not limited to:

collecting applications, and determining, according to text information of the collected applications, tags in the tag library that correspond to the applications.

Text information of an application includes but is not limited to text information such as a title and an introduction of the application. In the process of determining a tag in the tag library corresponding to the application according to text information of a collected application, a key word corresponding to the application may be first extracted according to the text information of the collected application, and degrees of association between the key word and the characteristic words in the tag library are calculated, whereby characteristic words in the tag library that match the application are determined, and a corresponding tag is obtained by using the matching characteristic words, where the tag can be deemed as a tag corresponding to the application. For example, assuming that the name of a game application includes a word “antivirus” and the tag library includes a characteristic word “antivirus”, when the degree of association between “antivirus” used as a key word and the characteristic word “antivirus” in the tag library is calculated, the value of the degree of association should satisfy a matching range, so that the tag corresponding to the application can be determined as “antivirus”.

After tags in the tag library that correspond to the applications are determined according to text information of the collected applications by using the foregoing process, because each tag in the tag library corresponds to one category of applications, after step 201 of converting the search word to a corresponding tag, the applications corresponding to the tag may be found through query according to the tag, and the applications are used as a search result corresponding to the search word.

In addition, because the applications are one category of applications corresponding to one tag, the applications found by using the tag obtained through conversion are one or more applications, that is, there are one or more search results.

203: Display the applications in order.

As regards this step, when multiple applications are found in step 202, the multiple applications found may be sorted first and then displayed according to the sorting result and thus presented to the user.

When the multiple applications found are being sorted, the multiple applications found may be sorted in alphabetical order of the first letter in the name of each of the applications. In addition, other sorting methods may also be used, for example, the multiple applications found may be sorted according to the number of retrievals of each of the applications. This embodiment does not specifically limit the specific sorting manner.

In the method provided in this embodiment, a search word is converted to a tag in a pre-constructed tag library, and applications are searched for according to the tag. Because the matching of search words and tags is relatively flexible, not only search limitations can be reduced, but also the flexibility of search can be improved.

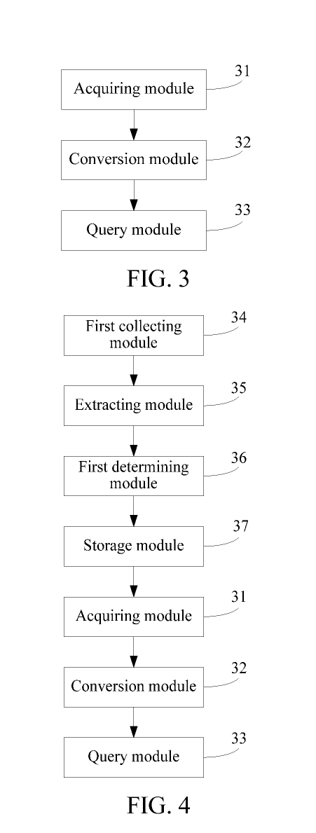

An embodiment of the present invention provides an application search apparatus. The apparatus is configured to execute the application search method provided in the embodiment shown in FIG. 1 or the embodiment shown in FIG. 2. Referring to FIG. 3, the apparatus includes:

an acquiring module 31, configured to acquire a search word;

a conversion module 32, configured to convert the search word acquired by the acquiring module 31 to a tag in a pre-constructed tag library, each tag in the tag library corresponding to one category of applications; and

a query module 33, configured to query for applications corresponding to the tag obtained through conversion by the conversion module 32, and use the applications as a search result corresponding to the search word.

Each tag in the pre-constructed tag library corresponds to one or more characteristic words; and

the conversion module 32 is configured to calculate degrees of association between the search word and the characteristic words in the tag library, and determine a characteristic word matching the search word according to the calculated degrees of association; and query for a tag corresponding to the matching characteristic word, and use the found tag as the tag obtained by converting the search word.

Further, referring to FIG. 4, the apparatus further includes:

a first collecting module 34, configured to collect search resources;

an extracting module 35, configured to extract key words from the search resources collected by the first collecting module 34;

a first determining module 36, configured to determine tags according to the key words extracted by the extracting module 35, and determine a characteristic word corresponding to each tag; and

a storage module 37, configured to store the tags and the characteristic words determined by the first determining module 36 into a corresponding database to obtain the tag library.

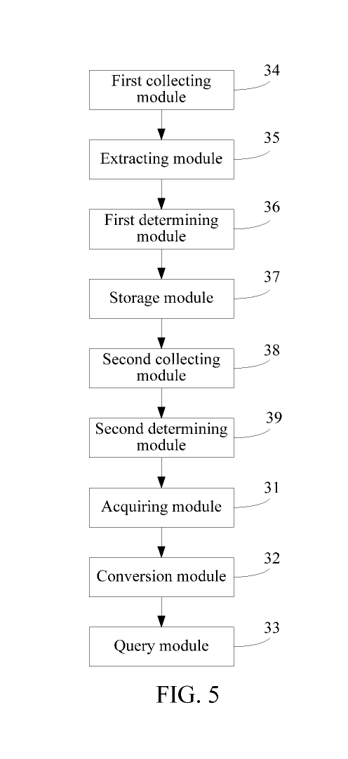

Further, referring to FIG. 5, the apparatus further includes:

a second collecting module 38, configured to collect applications; and

a second determining module 39, configured to determine, according to text information of the applications collected by the second collecting module 38, tags in the tag library that correspond to the applications.

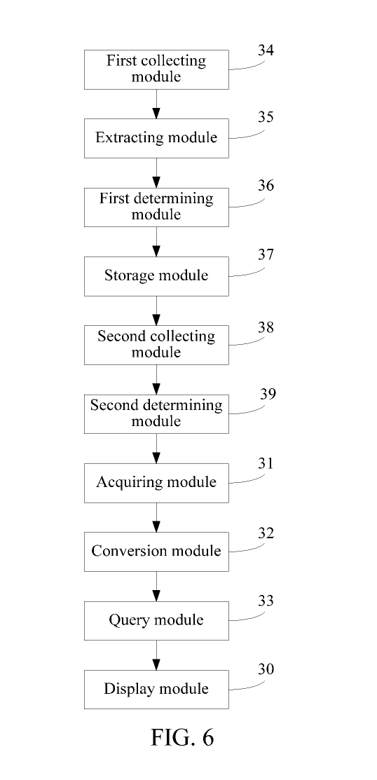

Further, referring to FIG. 6, the apparatus further includes:

a display module 30, configured to display the applications found by the query module 33 in order.

According to the apparatus provided in this embodiment, a search word is converted to a tag in a pre-constructed tag library, and applications are searched for according to the tag. Because the matching of search words and tags is relatively flexible, not only search limitations can be reduced, but also the flexibility of search can be improved.

An embodiment of the present invention provides a terminal, including: an application search apparatus.

The application search apparatus is the application search apparatus provided in any one of the embodiments corresponding to FIG. 3 to FIG. 6. For details, refer to the content of the embodiments corresponding to FIG. 3 to FIG. 6.

According to the terminal provided in this embodiment, a search word is converted to a tag in a pre-constructed tag library, and applications are searched for according to the tag. Because the matching of search words and tags is relatively flexible, not only search limitations can be reduced, but also the flexibility of search can be improved.

It should be noted that the above functional modules are only described for exemplary purposes when the application search apparatus provided by the foregoing embodiment searches for applications. In actual applications, the functions may be allocated to and implemented by different functional modules as required, which means that the internal structure of the apparatus is divided to different functional modules to complete all or some of the above described functions. In addition, the terminal and the application search apparatus that are provided by the foregoing embodiments are based on the same concept as the application search method in the foregoing embodiments. For the specific implementation process, refer to the method embodiments, and the details are not described herein again.

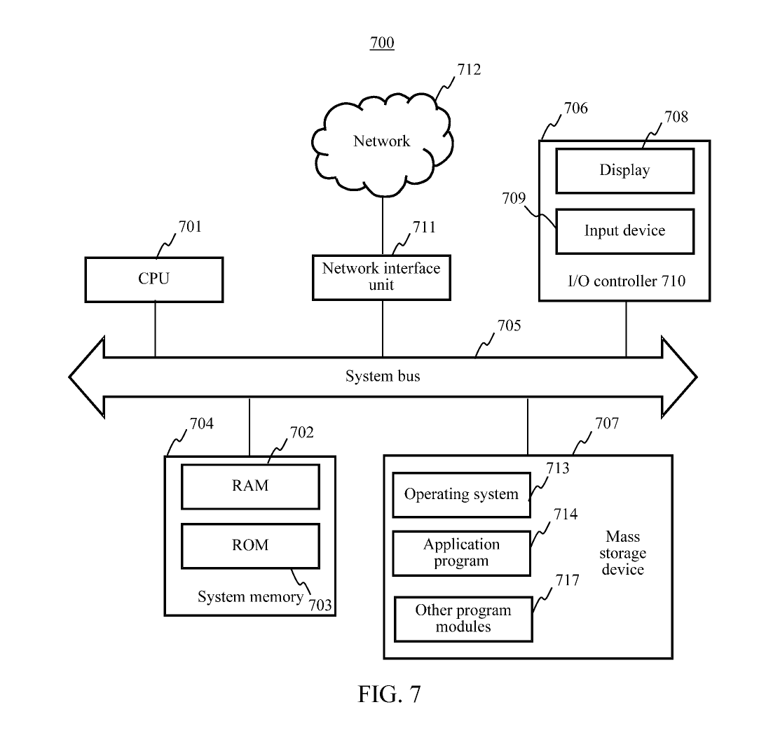

FIG. 7 is a schematic structural diagram of a terminal according to an embodiment of the present invention. The terminal 700 includes one or more processors, for example, a microprocessor, a central processing unit (CPU) or any other processor that can control software execution. This embodiment is described by using a CPU 701 as an example. The terminal 700 may further include a system memory 704 (including a random access memory (RAM) 702 and a read-only memory (ROM) 703) and a system bus 705 connecting the system memory 704 and the CPU 701. The terminal 700 further includes a basic input/output system (I/O system) 706 that helps components in a computer to transmit information, and a mass storage device 707 configured to store an operating system 713, an application program 714, and other program modules 717.

The basic I/O system 706 includes a display 708 configured to display information and an input device 709 configured to allow a user to input information, such as a mouse or a keyboard. The display 708 and the input device 709 are both connected to the CPU 701 by means of an input/output (I/O) controller 710 connected to the system bus 705. The basic I/O system 706 may further include the I/O controller 710 to receive and process inputs from multiple other devices such as a keyboard, a mouse, or an electronic stylus. Similarly, the I/O controller 710 also provides output to a display screen, a printer or other types of output devices.

The mass storage device 707 is connected to the CPU 701 by means of a mass storage controller (not shown) connected to the system bus 705. The mass storage device 707 and a related computer readable medium provide nonvolatile storage for the terminal 700. That is, the mass storage device 707 may include a computer readable medium (not shown) such as a hard disk or a CD-ROM driver. The operating system 713 stored in the mass storage device 707 may be Windows Server™, Mac OS X™, Unix™, Linux™, FreeBSD™, or the like. The application program 714 and other program modules 717 may include one or more modules (not shown in the figure), and each module may include a series of instructions or operations on a server.

Without loss of generality, the computer readable medium may include a computer storage medium and a communication medium. The computer storage medium includes volatile and nonvolatile, removable and non-removable media implemented by any method or technology used for storing information such as a computer readable instruction, a data structure, a program module or other data. The computer storage medium includes a RAM, a ROM, an EPROM, an EEPROM, a flash memory or other solid-state storage, a CD-ROM, a DVD or other optical storage, and a cassette, a magnetic tape, a magnetic disk storage or other magnetic storage devices. Certainly, a person skilled in the art may know that the computer storage medium is not limited to those media described above.

According to various embodiments of the present invention, the server 700 may further be connected to a remote computer on a network for running via a network such as the Internet. That is, the server 700 may be connected to a network 712 by means of a network interface unit 711 connected to the system bus 705, or the server 700 may also be connected to other types of networks or remote computer systems (not shown) by means of the network interface unit 711.

The system memory 704 and the mass storage device 707 may be collectively called as a memory. The memory further includes one or more programs. The one or more programs are stored in the memory, and are configured to be executed by one or more CPUs 701 to implement the application search method provided in the embodiment shown in FIG. 1 and the application search method provided in the embodiment shown in FIG. 2.

The sequence numbers of the foregoing embodiments of the present invention are merely for the convenience of description, and do not imply the preference among the embodiments. The disclosed methods and apparatus solve the problem of mobile searching on a terminal device. The terminal device may adopt a relatively flexible method to match search words and tags, which not only reduces search limitations, but also improves the flexibility of search in the terminal device.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. An application search method, comprising:
acquiring a search word and converting the search word to a tag in a pre-constructed tag library, the tag in the tag library corresponding to one category of applications; and
querying for applications corresponding to the tag obtained through conversion, and using the applications as a search result corresponding to the search word.

2. The method according to claim 1, wherein at least one tag in the tag library corresponds to one or more characteristic words.

3. The method according to claim 2, wherein the converting the search word to a tag in a pre-constructed tag library, comprises:
calculating degrees of association between the search word and the characteristic words in the tag library, and determining a characteristic word matching the search word according to the calculated degrees of association; and
querying for a tag corresponding to the matching characteristic word, and using the tag as the tag obtained by converting the search word.

4. The method according to claim 2, wherein before the converting the search word to a tag in a pre-constructed tag library, the method further comprises:
collecting search resources and extracting key words from the collected search resources;
determining tags according to the extracted key words, and determining a characteristic word corresponding to the tag; and
storing the determined tags and characteristic words into a corresponding database to obtain the tag library.

5. The method according to claim 1, wherein before the querying for applications corresponding to the tag obtained through conversion, the method further comprises:
collecting applications, and determining, according to text information of the collected applications, tags in the tag library that correspond to the applications.

6. The method according to claim 1, wherein after the using the applications as a search result corresponding to the search word, the method further comprises:
displaying the applications in order.

7. A terminal, comprising:
one or more processors; and
a non-transitory memory,
the non-transitory memory configured to store one or more programs, the one or more programs being configured to be executed by the one or more processors, and the one or more programs comprising instructions used for executing operations comprising:
acquiring a search word and converting the search word to a tag in a pre-constructed tag library, the tag in the tag library corresponding to one category of applications; and
querying for applications corresponding to the tag obtained through conversion, and using the applications as a search result corresponding to the search word.

8. The terminal according to claim 7, wherein the tag in the tag library corresponds to one or more characteristic words.

9. The terminal according to claim 8, wherein the one or more programs further comprise instructions for executing the following operations:
calculating degrees of association between the search word and the characteristic words in the tag library, and determining a characteristic word matching the search word according to the calculated degrees of association; and
querying for a tag corresponding to the matching characteristic word, and using the tag as the tag obtained by converting the search word.

10. The terminal according to claim 8, wherein the one or more programs further comprise instructions for executing the following operations:
collecting search resources and extracting key words from the collected search resources;
determining tags according to the extracted key words, and determining a characteristic word corresponding to each tag; and
storing the determined tags and characteristic words into a corresponding database to obtain the tag library.

11. The terminal according to claim 7, wherein the one or more programs further comprise an instruction for executing the following operations:
collecting applications, and determining, according to text information of the collected applications, tags in the tag library that correspond to the applications.

12. The terminal according to claim 7, wherein the one or more programs further comprise an instruction for executing the following operation:
displaying the applications in order.

13. A non-transitory storage medium having stored therein one or more instructions configured to be executed by a terminal, causing the terminal to:
acquire a search word and convert the search word to a tag in a pre-constructed tag library, the tag in the tag library corresponding to one category of applications; and
query for applications corresponding to the tag obtained through conversion, and using the applications as a search result corresponding to the search word.

14. The non-transitory storage medium according to claim 13, wherein the tag in the tag library corresponds to one or more characteristic words.

15. The non-transitory storage medium according to claim 14, wherein the instructions further causes the terminal to:
calculate degrees of association between the search word and the characteristic words in the tag library, and determining a characteristic word matching the search word according to the calculated degrees of association; and
query for a tag corresponding to the matching characteristic word, and use the tag as the tag obtained by converting the search word.

16. The non-transitory storage medium according to claim 14, wherein instructions further causes the terminal to:
collect search resources and extracting key words from the collected search resources;
determine tags according to the extracted key words, and determine a characteristic word corresponding to each tag; and
store the determined tags and characteristic words into a corresponding database to obtain the tag library.

17. The non-transitory storage medium according to claim 13, wherein the instructions further causes the terminal to:
collect applications, and determine, according to text information of the collected applications, tags in the tag library that correspond to the applications.

18. The non-transitory storage medium according to claim 13, wherein the instructions further causes the terminal to display the applications in order.
